(19) United States
(12) Patent Application Publication
(10) Pub. No.: US 2025/0353472 A1
(43) Pub. Date: Nov. 20, 2025

(54) INTERIOR WINDSHIELD CLEANING ROBOT

(71) Applicant: Serve Interactive, LLC, Vista, CA (US)

(72) Inventor: Andre Anderson, Oceanside, CA (US)

(21) Appl. No.: 19/208,483

(22) Filed: May 14, 2025

Related U.S. Application Data
(60) Provisional application No. 63/648,485, filed on May 16, 2024.

(51) Int. Cl. B60S 3/00; B08B 3/02; B08B 3/10; B08B 13/00; B62D 57/024

(52) U.S. Cl. CPC B60S 3/008; B08B 3/024; B08B 3/10; B08B 13/00; B62D 57/024

(57) ABSTRACT

A windshield cleaning robot and methods for cleaning vehicle interior windshields. The robot adheres to and traverses the interior surface of a vehicle's windshield. The robot includes a chassis with a suction pad that creates a vacuum seal, allowing the robot to maintain adherence to the windshield at various angles of inclination. A cleaning element, which extends over the bottom surface of the chassis, is used to remove foreign materials from the glass surface. The robot is propelled across the windshield by a propulsion system while remaining adhered to the glass. The robot and methods provide an efficient and thorough cleaning of the windshield, particularly addressing the challenge of reaching lower and far corners which are typically difficult to clean manually.

### CLAIM OF PRIORITY

This application claims the benefit of priority under 35 U.S.C. § 119 (e) to U.S. Provisional Patent Application Ser. No. 63/648,485, filed on May 16, 2024, which is incorporated by reference herein in its entirety.

### TECHNICAL FIELD

The present disclosure generally relates to automated cleaning systems and more particularly to autonomous robots for cleaning vehicle interior windshields.

### BACKGROUND

Autonomous household cleaning robots are used to simplify the cleaning of building interiors, including window surfaces. Some robots are able to maintain contact with vertical window surfaces using suction while using wheels or rollers to traverse a planar vertical window surface.

### SUMMARY

Vehicle windshields often accumulate films and residues on their interior surfaces that can impair visibility and safety due to increased glare and reduced overall visibility. These residues typically originate from environmental dust and off-gassing from interior components such as the dashboard. Traditional methods of cleaning windshield interior surfaces involve manual wiping, which can be cumbersome and ineffective in reaching tight corners. Additionally, manual cleaning does not always provide a consistent level of cleanliness across the entire surface. Thus, there is a continuous need for improved technologies that can efficiently and effectively maintain the clarity of windshield surfaces.

Conventional window cleaning robots are generally designed for flat, vertical surfaces such as home or office windows and often lack the necessary adaptations to handle the unique challenges presented by vehicle interior windshields. These challenges include the curvature of the windshield surface, the complex shape of the windshield, the obstructions within the vehicle making various portions of the windshield difficult to access, the orientation and inclination of the windshield, and the size and complexity of conventional cleaning robots.

Vehicle windshields typically have a significant curvature, which can prevent conventional robots, which are designed for flat surfaces, from maintaining adequate contact and suction needed to adhere to and move across the surface. The interior space of a vehicle is confined and features complex shapes and obstructions placed close to the windshield, particularly in the deep bottom corners with very little clearance above the dashboard. Most conventional robots are not designed to navigate such tight and intricate spaces effectively.

The orientation and inclination of vehicle windshields also varies significantly compared to standard windows. Conventional robots may not be able to maintain adherence or function effectively at the angles required for interior windshield cleaning. Furthermore, most conventional window cleaning robots are designed for cleaning large window surfaces of buildings and are too large and bulky to be effectively used, stored, and serviced inside a vehicle. A smaller, more compact design is essential for maneuvering within the limited space available close to a vehicle interior windshield. A smaller design also enables the robot to be stored conveniently within the vehicle, and makes it more convenient to service the robot (e.g., charging, refilling with cleaning fluid, changing the cleaning pad, cleaning any filters) on the road or inside the vehicle.

Due to these factors, conventional window cleaning robots are often unsuitable for cleaning vehicle interior windshields. Examples described herein may provide a windshield cleaning robot with a small form factor and low height profile designed to traverse the entire surface of a vehicle interior windshield. Examples described herein may address one or more of the challenges described above.

### BRIEF DESCRIPTION OF THE DRAWINGS

To easily identify the discussion of any particular element or act, the most significant digit or digits in a reference number refer to the figure number in which that element is first introduced.

FIG. 1 is a system diagram illustrating functional systems of a windshield cleaning robot, according to some examples.

FIG. 2 illustrates a top plan view of an example windshield cleaning robot, according to some examples.

FIG. 3 illustrates a front view of a wheel of the example windshield cleaning robot of FIG. 2, according to some examples.

FIG. 4 illustrates a side view of the example windshield cleaning robot of FIG. 2, according to some examples.

FIG. 5 illustrates a side cross-sectional view of the example windshield cleaning robot of FIG. 2, according to some examples.

FIG. 6 illustrates a bottom plan view of the example windshield cleaning robot of FIG. 2, according to some examples.

FIG. 7 illustrates a method of cleaning a vehicle interior windshield, according to some examples.

FIG. 8 illustrates an example of paths traversed by a windshield cleaning robot in cleaning a vehicle interior windshield, according to some examples.

### DETAILED DESCRIPTION

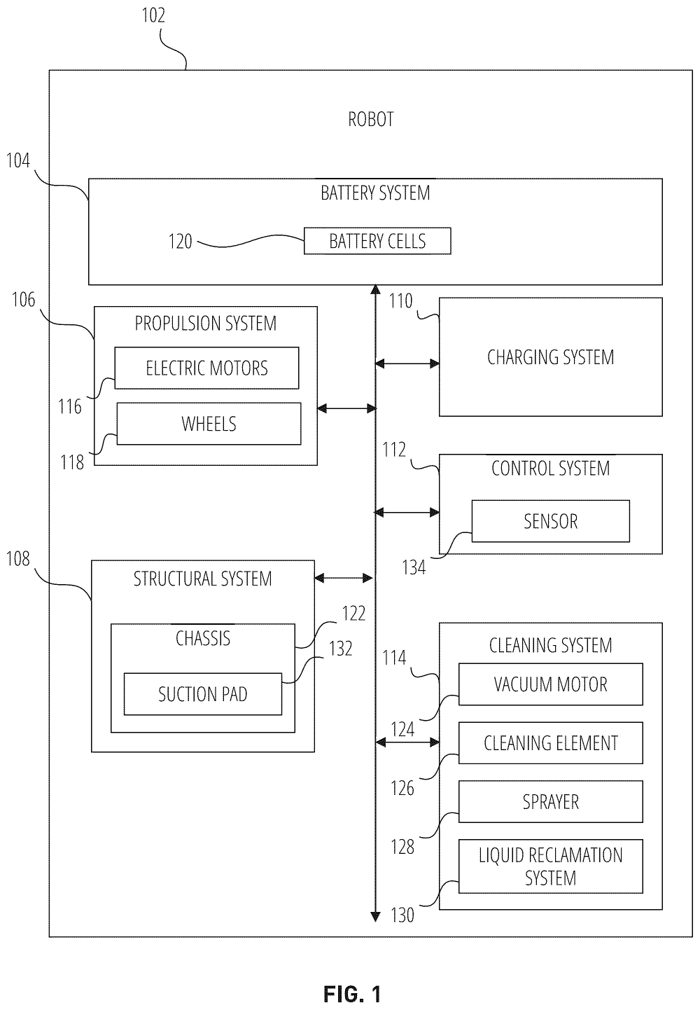

FIG. 1 is a system diagram illustrating an architecture of a robot 102, according to some examples. This diagram shows systems and sub-systems that collectively enable the functionality of the robot 102. The robot 102 is a windshield cleaning robot for cleaning a vehicle interior windshield, with structural details and cleaning functionality as described in the subsequent figures.

The robot 102 includes a number of higher-level systems which are interconnected, including a battery system 104, a propulsion system 106, a structural system 108, a charging system 110, a control system 112, and a cleaning system 114.

The battery system 104 includes one or more battery cells 120. The battery cells 120 may be based on various chemistries, including lithium-ion, lithium-polymer, nickel-metal hydride, or solid-state materials, each offering distinct advantages in terms of energy density, recharge cycles, and safety profiles. In some examples, a first one or more battery cells 120 power the vacuum motor 124 of the robot 102, and a second one or more battery cells 120 power the electric motors 116 and other electrically powered systems of the robot 102 (e.g., the control system 112, charging system 110, sprayers 128, liquid reclamation system 130, and so on). The first one or more battery cells 120 may include two 450 milliamp hour (mAH), 11.1 volt batteries for powering the vacuum motor 124. The second one or more battery cells 120 may include a single 450 mAH, 7.4 volt battery. Other suitable arrangements of power battery cells 120 can be used in different embodiments to power the components of the robot 102.

The propulsion system 106 includes one or more electric motors 116, which may include traction motors for propulsion, converting electrical energy into mechanical energy. The propulsion system also includes two or more wheels 118 driven by the one or more electric motors 116. The wheels 118 can be coupled to the electric motors 116 by components such as axles or other mechanical transmission means, such that the mechanical energy generated by the electric motors 116 is transmitted to drive the wheels 118 and thereby propel the robot 102 across a surface.

The structural system 108 includes a chassis 122, providing the physical framework and support for the robot 102. In some examples, all of the components of the robot 102 are coupled to the chassis 122 and supported by the chassis 122 and wheels 118. The chassis 122 defines a suction pad 132 for providing a suction force, in conjunction with the vacuum motor 124 described below as part of the cleaning system 114.

The charging system 110 operatively replenishes the stored energy within the battery system 104 of the robot 102. In various embodiments, the charging system 110 can support various suitable charging methodologies.

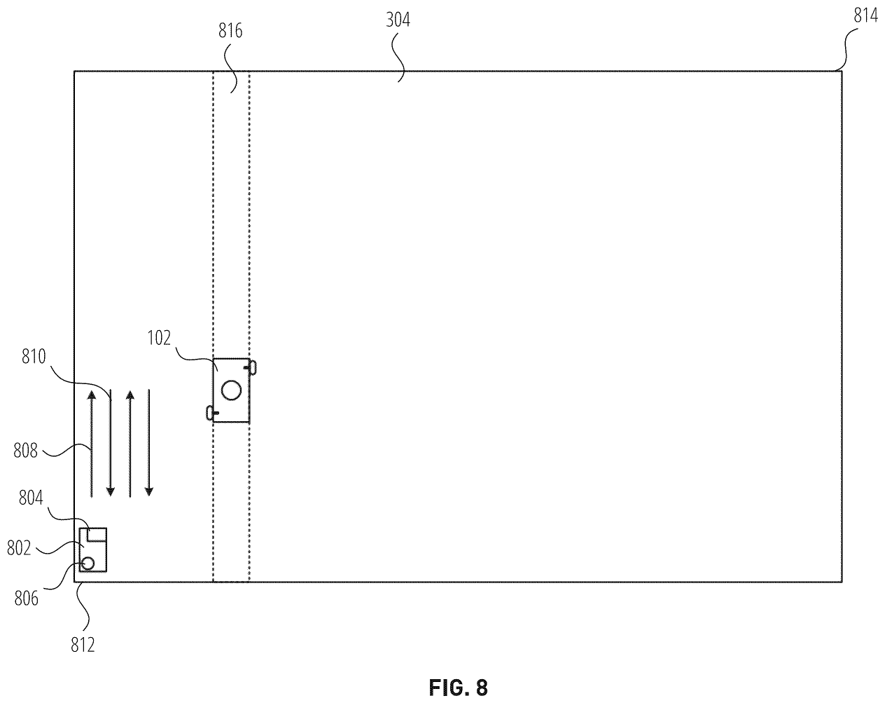

For charging from a wall outlet or vehicle power outlet, the charging system 110 may include an onboard charger for AC/DC conversion. This onboard charger converts the alternating current (AC) from the electrical grid, home outlets (e.g., 108-120V), or some vehicle outlets into direct current (DC) that can be stored in the vehicle's battery system 104. In some examples, the charging system 110 supports direct DC charging from DC outlets of a vehicle. In some examples, tethered operation of the robot 102 may be possible by plugging a charging cable of the robot 102 into an outlet of the vehicle to provide constant power to the robot 102, such as a 12 volt, 10 ampere vehicle power outlet. In such examples, the robot 102 may be configured to operate its cleaning system 114 and propulsion system 106 at 120 watts or less. In some examples, the charging system 110 is configured to interface with a charging port of a base for the robot, as described with reference to FIG. 8 below.

The control system 112 controls the other systems of the robot 102, such as the propulsion system 106 and the cleaning system 114. In some examples, the control system 112 can be used to steer the robot 102 using a dedicated steering mechanism (not shown). In some examples, the wheels 118 can be driven at different levels of torque to steer the robot 102. The control system 112 can control the power provided to each electric motor 116 to drive, steer, and/or stop the robot 102. The charging system 110 can also control the drive of the vacuum motor 124, starting the vacuum motor 124 during cleaning and stopping the vacuum motor 124 when not cleaning. Similarly, the control system 112 can control the operations of the sprayers 128 and/or liquid reclamation system 130, such that liquid is sprayed and reclaimed during wet cleaning operations, but liquid is not sprayed during dry cleaning operations or when not cleaning.

In some examples, the control system 112 can include one or more controllers or processors for controlling the various systems of the robot 102. In some examples, the processors may be coupled to a memory for storing machine-readable and processor-executable instructions, such as software or firmware instructions for performing the methods described herein.

In some examples, the control system 112 includes on or more sensors 134 for assisting the robot 102 in navigating over the surface of the vehicle interior windshield 304. The sensors 134 can include a light sensor, a proximity sensor, an inertial measurement unit, and/or any other sensors suitable for orienting the robot 102 with respect to the vehicle interior windshield 304 or to a fixed location thereon (such as a base for the robot 102, as described with reference to FIG. 8 below).

The cleaning system 114 can include a vacuum motor 124, a cleaning element 126, one or more sprayers 128, and a liquid reclamation system 130. The operations of the cleaning system 114 and its components is described in greater detail below. The cleaning element 126 can be a flexible textured element such as a microfiber cloth, which extends across the bottom of the chassis 122 to contact the surface being cleaned. The vacuum motor 124 operates to pull air through the cleaning element 126 in a small gap between the chassis 122 and the surface being cleaned, thereby creating negative pressure within a cavity of the suction pad 132 and generating suction force effective to adhere the robot 102 to a curved surface of a vehicle interior windshield, regardless of the angle of inclination (e.g., upside-down at an angle of 30 to 80 degrees to horizontal). The sprayers 128 are operable by the control system 112 to spray liquid, such as water or a cleaning fluid (e.g., an alcohol-based glass cleaner), onto a surface of the cleaning element 126 when in a wet cleaning mode. A liquid reclamation system 130 operable by the control system 112 may also be included in some example embodiments to recover the used liquid from the cleaning element 126, such as by extracting the liquid from the stream of fluids sucked up by the vacuum motor 124. The liquid reclamation system 130 can redistribute the reclaimed liquid to the sprayers 128 for reuse, for example, after passing the reclaimed fluid through a filter to remove particulate matter or other solids.

In some examples, the cleaning system 114 can include additional components and/or can omit one or more of the components described above.

The vacuum motor 124 can be omitted in some examples, and suction can instead be provided by a different suction mechanism, such as a suction cup or other passive mechanical suction means. For example, the suction pad 132 or one or more additional mechanical suction cup components on the underside of the robot can provide a means for releasably securing the robot to the surface to be cleaned using mechanical force, such as pressure from a user's hand, to secure the robot to the surface by suction. The suction mechanism can create a seal or partial seal of the underside of the robot to the surface by evacuating air from a cavity adjacent to the surface, and surrounding the cavity with a deformable member such as a latex or rubber seal to maintain a pressure differential between the evacuated cavity and the surrounding atmosphere. In some examples, the evacuation of the air can be accomplished using powered means (such as a smaller vacuum motor that operates only when initially securing the robot to the surface) or manual means (such as pressing a deformable membrane against the surface with the user's hand, then allowing gravity or other biasing forces to pull the robot back away from the surface to tighten the seal). In some examples, the suction mechanism can be released through direct application of force (e.g., pulling the robot off of the surface by hand) or by a specialized releasing mechanism (such as a tab, button, or other manually controllable means to open a valve to break the seal and refill the cavity with air).

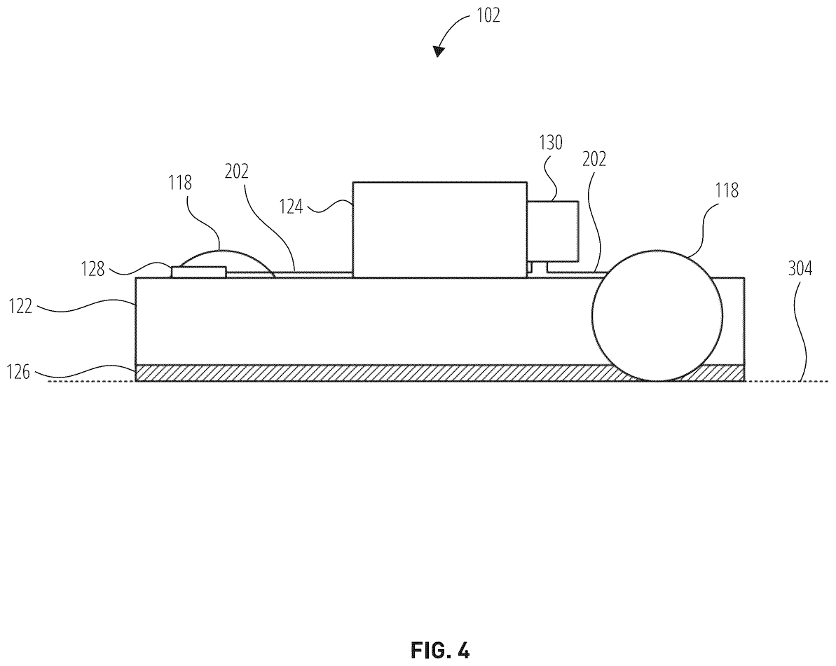

In some examples, the cleaning system 114 can include a scrubbing mechanism in addition to, or instead of, the cleaning element 126 as shown in FIG. 4 through FIG. 6 and/or the sprayers 128. For example, one or more rotating brushes can be coupled to a motor (such as a dedicated scrubbing motor or the electric motor 116) for scrubbing the surface being cleaned. These brushes can include one or more horizontal brushes rotating in a plane parallel to the surface bring cleaned and/or one or more vertical brushes rotating in a plane perpendicular to the surface being cleaned. In some cases, these brushes can be operated in conjunction with the sprayers 128 to scrub the surface aided by cleaning fluid from the sprayers 128.

The systems of the robot 102 may be communicatively connected, for example, via one or more vehicle communication buses, such as an Ethernet network.

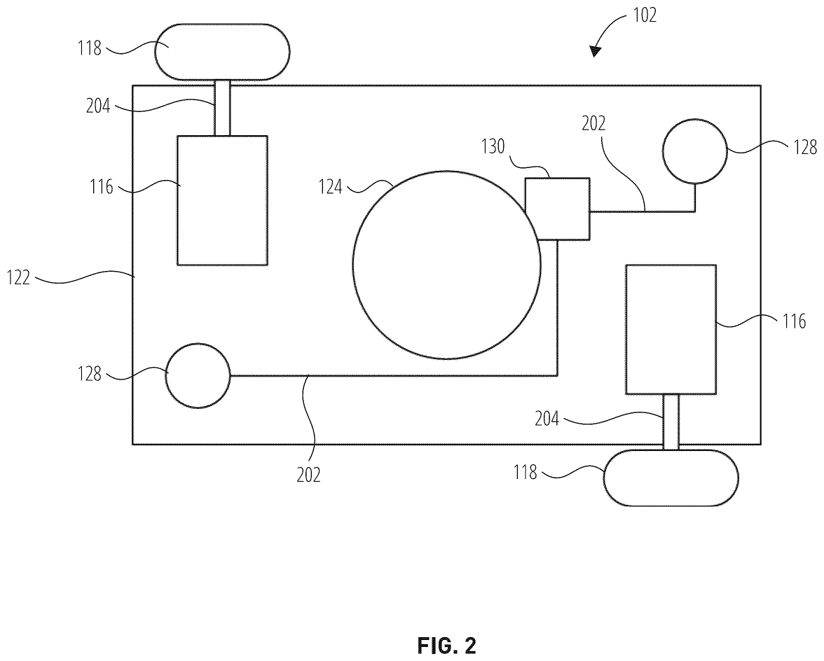

FIG. 2 shows a top plan view of an example structure of a windshield cleaning robot, shown as robot 102. The structure shown in FIG. 2 does not show all systems or subsystems of the robot 102 described with reference to FIG. 1 above: it will be appreciated that components not shown in FIG. 2, such as the battery system 104, charging system 110, and control system 112 can be coupled to the chassis 122 to enable electrical and data communication with the other components as appropriate.

Two wheels 118 are rotatably coupled to the chassis 122 by respective axles 204 driven by respective electric motors 116. In the illustrated example, only two wheels 118 are used, and they are coupled to the chassis 122 at diagonally opposite positions, such as one wheel 118 at a front right position and one wheel at a rear left position. Such a configuration allows the robot 102, when adhered to a surface via suction, to effectively steer, drive forward, and drive backward.

In some examples, more than two wheels may be used, and/or the positions of the wheels may be changed. In some examples, different surface-engaging means can be used in place of wheels 118, such as rollers, tracks, or treads.

The vacuum motor 124 is attached to the chassis 122 in a central location to create a relatively uniform suction force centered on the center of the chassis 122 when operating. This distributes the cleaning effect over the bottom surface of the robot 102 and equalizes the force adhering the robot 102 to the vehicle interior windshield, such that each wheel 118 and each peripheral portion of the chassis 122 experiences roughly equal force pulling it into engagement with the vehicle interior windshield.

The vacuum motor 124 operates to pull air through the cleaning element 126 and into a bottom cavity of the chassis 122, creating a negative pressure environment. This negative pressure is what allows the robot 102 to adhere to the windshield. The air pulled through the cleaning element 126 also assists in the removal of dust, dirt, and other debris from the glass surface of the windshield.

The liquid reclamation system 130 is coupled to the vacuum motor 124 to extract the liquid from the fluids passing through the vacuum motor 124. The liquid may be cleaned or filtered to remove solids, then redistributed to the sprayers 128 by liquid lines 202.

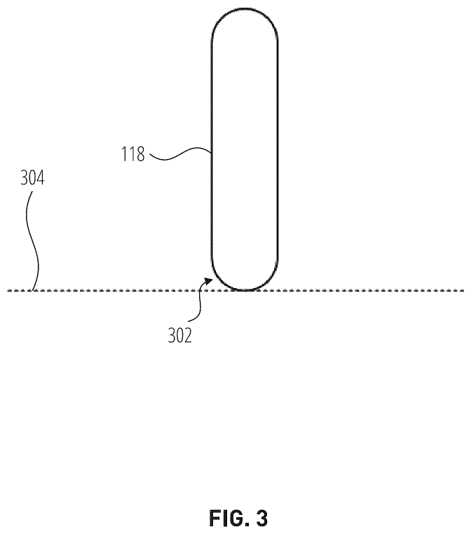

FIG. 3 shows a front view of a wheel 118 of the example windshield cleaning robot 102. In some examples, each wheel 118 has a rounded profile 302 to reduce a surface area of the wheel 118 in contact with the vehicle interior windshield 304. The rounded profile 302 of the wheels 118 reduces the amount of friction between the wheels 118 and the vehicle interior windshield 304, and is intended to overcome the friction of the cleaning element 126 against the vehicle interior windshield 304, assisting the wheels in turning and propelling the robot 102 in conditions of high suction force acting to pull the wheels 118 toward the vehicle interior windshield 304.

FIG. 4 shows a side view of the example windshield cleaning robot 102. The cleaning element 126 is shown extending over a bottom surface of the chassis 122 and in contact with the vehicle interior windshield 304. The cleaning element 126 is configured to remove foreign material from a glass surface, such as the vehicle interior windshield 304.

The wheels 118 are in contact with the vehicle interior windshield 304 to propel the robot 102 across the surface of the vehicle interior windshield 304.

A top portion of one sprayer 128 is visible above the chassis 122, coupled to the liquid reclamation system 130 by a liquid line 202. The vacuum motor 124 rises above the chassis 122 in the illustrated example.

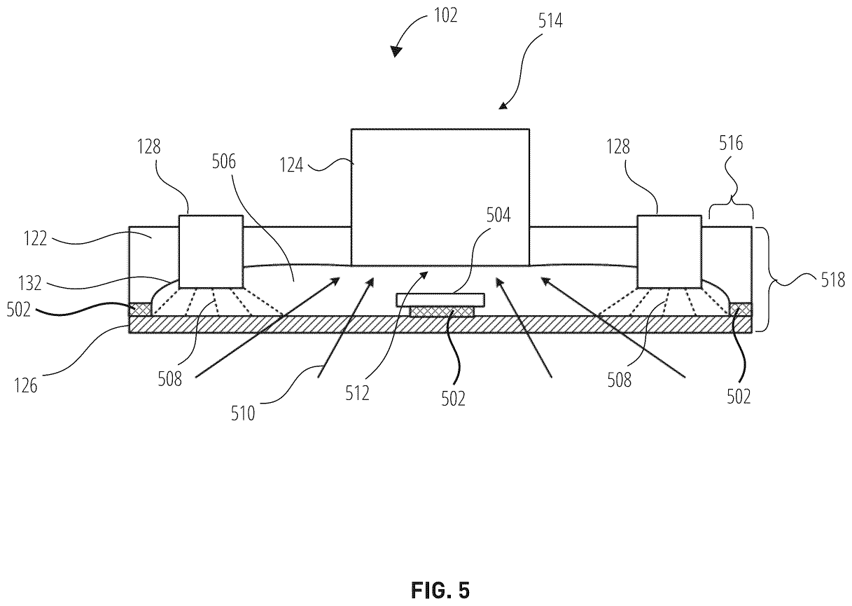

FIG. 5 shows a side cross-sectional view of the example windshield cleaning robot 102. The chassis 122 includes a suction pad 132 defining a bottom cavity 506. The cavity 506 is defined by a concave surface of the bottom of the suction pad 132, extending to the periphery of a bottom surface of the chassis 122.

The cleaning element 126 extends over the bottom surface of the chassis 122 to cover the cavity 506. The vacuum motor 124 pulls air through an aperture 512 at the top of the cavity 506. This air is pulled through the cleaning element 126. When the cleaning element 126 is in contact with the vehicle interior windshield 304, the air is pulled through the small gap between the bottom surface of the chassis 122 and the vehicle interior windshield 304, generating negative pressure within the cavity 506. The negative pressure is sufficient to adhere the robot 102 to the curved surface of the vehicle interior windshield at any angle of inclination, as described above. The strength of the adhesion is a function of the structure of the robot 102, the power of the vacuum motor 124, and the weight of the robot 102. In some examples, the robot 102 weighs less than 20 ounces and the vacuum motor 124 is configured to operate at a speed of more than 75,000 rotations per minute (RPM), resulting in a suction force of more than 5,000 Pascals. In some examples, the robot 102 weighs less, such as less than 18 ounces or less than 15 ounces, depending on the specific components used in the robot 102. In some examples, the vacuum motor 124 operates at a higher speed, such as 80,000 RPM, or at a lower speed (such as 60,000 RPM) if the robot 102 is lighter or less adhesion is required. In some examples, the suction force may be lower, such as more than 3,000 Pascals. The torque applied by the electric motors 116, the rounded profile 302 of the wheels, the speed of propulsion of the robot 102, and the power consumption of the electric motors 116 may all be adjusted or affected by the suction force generate by the vacuum motor 124. Thus, various examples may realize different trade-offs between power consumption (by the electric motors 116 and vacuum motor 124), the speed of propulsion, the wheel design, and the stability of the adhesion of the robot 102 to the vehicle interior windshield 304. A suction force of 6,000. Pascals, as generated by an 80,000 RPM vacuum motor 124, may provide roughly four pounds of force, or approximately three to four times the force needed to adhere an 18-ounce robot 102 to the vehicle interior windshield 304 at conventional windshield curvatures and angles of inclination.

The chassis 122 and its components have a low height profile 514 suitable to permit passage of at least a portion of the chassis over each corner of the vehicle interior windshield 304, including into the deep, low-clearance bottom corners of the vehicle interior windshield 304 above the vehicle dashboard. The low height profile 514 of the chassis 122 may include at least one peripheral portion 516 of the chassis 122 (e.g., at a corner or edge of the chassis) having a height 518 of less than 3 inches from the vehicle interior windshield 304. In some examples, the chassis 122 has at least one peripheral portion 516 having a height of less than 2.5 inches, such as 2 inches. The other dimensions of the chassis 122 impart an overall small form factor on the robot 102: in some examples, the chassis 122 is between 4 and 5 inches in width and between 4 and 6 inches in length. The suction pad 132 can be of various dimensions in different examples, such as between 1 and 3 inches in width and between 2 and 4 inches in length. The dimensions of the suction pad can be selected to affect the suction force: the estimates given above for an 80,000 RPM vacuum motor 124 generating 4 pounds of suction force are premised on a suction pad 132 with an area of approximately 4 to 5 square inches.

In some examples, the chassis 122 and associated components can be very small, such that the footprint of the robot on the surface being cleaned is less than 4 inches by 4 inches. Some examples that omit the vacuum motor 124 and use a passive suction mechanism, as described above, may be able to use a smaller battery system 104 due to the lower power consumption requirements of the robot. A smaller and lighter form factor reduces the required suction force to secure the robot to the surface and the required propulsion force to move the robot across the surface. A small form factor also improves the robot's ability to access corners and edges of the windshield or other surface being cleaned.

The cleaning element 126 can be secured to the bottom surface of the chassis 122 by various means, including detachable attachment means such as hook and loop fasteners (e.g., Velcro™). In some examples, the cleaning element 126 is formed from a fibrous material having a pile that engages with hook fasteners, such that a separate complementary loop-fastener surface is not needed. In the illustrated example, hook and loop fastener surfaces 502 are shown extending around a peripheral strip of the bottom surface of the chassis 122. In some examples, a cross support 504 extending across the bottom of the cavity 506 can also be used to provide further support and structure to the cleaning element 126 to ensure proper engagement of the cleaning element 126 to the vehicle interior windshield 304. The cross support 504 can also feature a hook and loop fastener surface 502 for further securing the cleaning element 126.

In operation, the vacuum motor 124 pulls air through the cleaning element 126, shown as solid arrows denoting suction 510. It will be appreciated that, when placed against the vehicle interior windshield 304 or another surface, the air is restricted to passing through the sides of the cleaning element 126, creating a greater suction force between the chassis 122 and the vehicle interior windshield 304. The suction 510 pulls foreign material through the cleaning element 126 and through the aperture 512, where the air can pass out of a top side of the vacuum motor 124, and any liquids contained in the stream of fluids pulled in by the suction 510 can be recovered by the liquid reclamation system 130.

During a wet cleaning operation, the sprayers 128 can be controlled to spray liquid (such as water or another cleaning fluid as described above) onto a surface of the cleaning element 126, as shown by liquid spray 508. It will be appreciated that some examples may use sprayers or other liquid injection or distribution means to supply cleaning fluids to the cleaning element 126. In some examples, the cleaning fluids may be distributed around one or more peripheral portions of the cleaning element 126, such that the cleaning element 126 can spread them across the vehicle interior windshield 304 during propulsion of the robot 102 without the cleaning fluids being immediately pulled off out of the cleaning element 126 by suction 510.

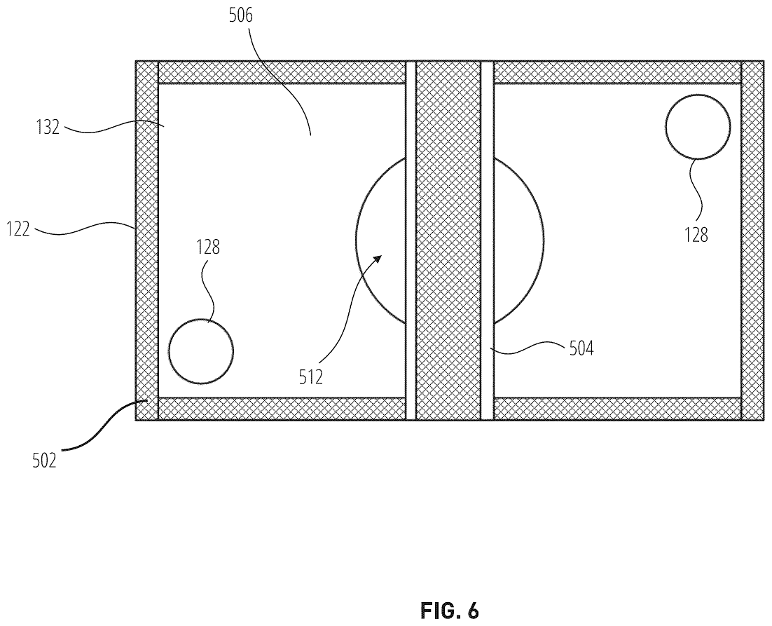

FIG. 6 shows a bottom plan view of the example windshield cleaning robot 102, with the cleaning element 126 removed for visibility. The cross support 504 is shown extending across the bottom of the cavity 506. The aperture 512 is shown as a circular aperture in the center of the top surface of the cavity 506. The sprayers 128 are shown at the front left and back right corners of the cavity 506; however, it will be appreciated that some examples may use one sprayer 128, more than two sprayers 128, or sprayers 128 or other fluid distribution means located elsewhere to distribute cleaning fluid to the cleaning element 126.

The hook and loop fastener surfaces 502 (e.g., surfaces having arrays of hook fasteners) are shown extending around a peripheral strip around the bottom surface of the chassis 122, and along a bottom surface of the cross support 504.

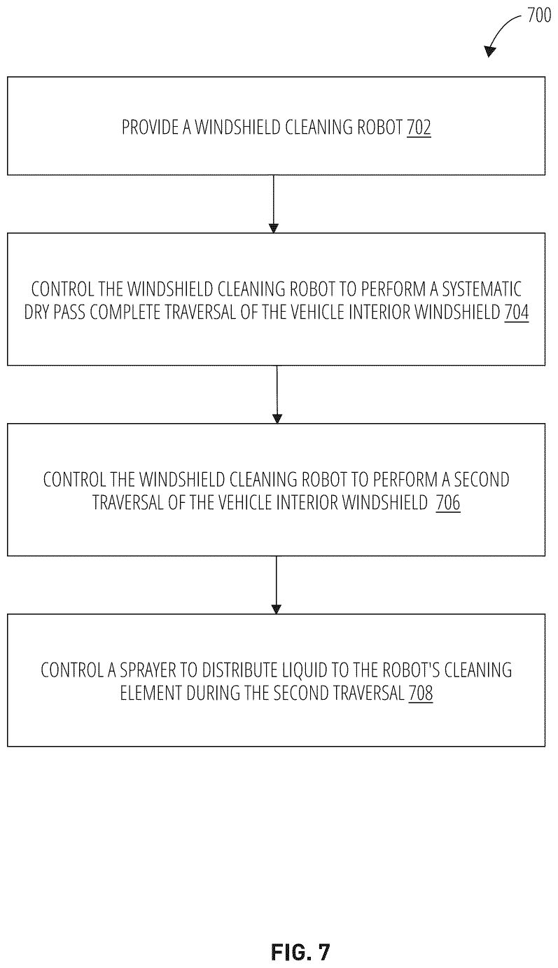

FIG. 7 illustrates an example method 700 of cleaning a vehicle interior windshield. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

According to some examples, the method 700 includes providing a windshield cleaning robot at operation 702. The windshield cleaning robot is described as robot 102 in this example, but it will be appreciated that various windshield cleaning robots could be used as long as they have the capabilities necessary to perform the method 700.

According to some examples, the method 700 includes controlling the windshield cleaning robot 102 to perform a complete traversal of the vehicle interior windshield 304 at operation 704. The complete traversal can be performed as a systematic traversal of the vehicle interior windshield 304. For example, the complete traversal can begin at a first corner of the vehicle interior windshield (e.g., the upper left corner, above the driver side seat) and end at a second corner of the vehicle interior windshield 304 diagonally opposite the first corner (e.g., the lower right corner near the passenger side dashboard). The robot 102 can systematically traverse the entire exposed area of the vehicle interior windshield 304 with at least a portion of the cleaning element 126, for example, by travelling in rows or columns from one edge of the vehicle interior windshield 304 to an opposite edge and turning at the end of each row or column to begin the next adjacent or overlapping row or column.

In some examples, the complete traversal is a dry pass, intended to remove particulate matter, and is performed without liquid on the cleaning element. This may also be referred to herein as a dry cleaning operation. Thus, in such examples, the sprayers 128 (and/or the liquid reclamation system 130) may be inactive during the complete traversal.

The path taken by the robot 102 during the complete traversal is effectuated by the propulsion system 106 under the control of the control system 112. During the complete traversal, the vacuum motor 124 remains active, thereby assisting in the cleaning operation and adhering the robot 102 to the vehicle interior windshield 304.

According to some examples, the method 700 includes controlling the windshield cleaning robot 102 to perform a second traversal of the vehicle interior windshield at operation 706. The second traversal can be performed as the complete traversal of operation 704. In some examples, the second traversal is performed in reverse: e.g., from the second corner to the first corner. This allows the robot 102 to be retrieved from the same location where it was initially placed by the user, potentially limiting the risk of placing hand smudges on the glass of the windshield when retrieving the robot 102.

According to some examples, the method 700 includes controlling at least one sprayer 128 to distribute liquid to the robot's cleaning element during the second traversal at operation 708. In some examples, the second traversal is a wet cleaning operation, in which cleaning fluid is sprayed by the sprayers 128 onto a surface of the cleaning element 126 (or otherwise distributed onto the 126), and the cleaning element 126 uses the cleaning fluid to assist its cleaning operations.

In some examples, the liquid reclamation system 130 is also activated during the second traversal to reclaim the liquid pulled in by the vacuum motor 124, as described above.

In some examples, both the complete traversal and the second traversal are each relatively quick. For example, each of the two traversals can be completed in less than 5 minutes in some examples, such as between 2 and 5 minutes each over a vehicle interior windshield of less than 14 square feet (e.g., 13 square feet).

In some examples, a further dry pass is performed after the second traversal to dry the vehicle interior windshield. This second dry pass is performed as the complete traversal of operation 704.

FIG. 8 illustrates an example of paths traversed by the example windshield cleaning robot 102 in cleaning a vehicle interior windshield 304. In this example, the robot 102 has a base 802 attached to the vehicle interior windshield 304 at a lower left corner (shown as starting corner 812). The base 802 can be attached using suction pads, adhesives, or any other suitable means. In some examples, the base 802 functions as a charging pad, providing a charging port 804 with which the charging system 110 of the robot 102 can interface; the base 802 can receive electrical power from a cable attached to a vehicle outlet, as described above. The base 802 can also include means for assisting the robot 102 in navigation and alignment with the base 802, such as a light 806 or beacon that can be sensed by the sensor 134 when the robot 102 is traversing the vehicle interior windshield 304 or coupling with the base 802.

In this example, a cleaning operation (such as the first complete traversal of operation 704) can begin at the starting corner 812, with the robot 102 coupled to the base 802. The cleaning operation can be triggered by user input, such as pressing a button or transmitting a command from a remote device, or it can be triggered by internal conditions such as a predetermined schedule. The robot 102 traverses a first upward path 808 to the top of the vehicle interior windshield 304, turns to the right and travels for a distance of half the width of the robot 102, then turns right again and traverses a downward path 810 overlapping with the first upward path 808 to reach the bottom of the vehicle interior windshield 304. This is followed by a left turn and further half-width travel, with this process repeating to clean a series of overlapping paths (each path defining a column 816) until the robot 102 reaches an ending corner 814 diagonally opposite the starting corner 812.

As described above, second and/or third cleaning operations can be performed (such as the second traversal and/or a further dry pass) after the first complete traversal. Each of these cleaning operations can be performed beginning in the same corner where the previous cleaning operation began. In some examples, the robot 102 can return to the base 802 after all cleaning operations are complete, and/or in between cleaning operations.

In some examples, the sensors 134 include one or more optical sensors configured to detect two or more colors of light. The base 802 can include two or more lights 806 of different colors having different locations and/or orientations, such that the sensors 134 can be used by the robot to determine the location and/or orientation of the robot 102 relative to the base 802 by detecting the different colors of light from the two or more lights 806. In some examples, the optical sensors can also be used to detect other objects in the environment, such as edges of the vehicle interior windshield 304, in order to more effectively navigate. For example, the same optical sensors used to detect the lights 806 can be used to detect edges of the vehicle interior windshield 304 and/or other obstructions within a range of 5 to 10 centimeters, thereby enabling the robot 102 to turn at the edges of the vehicle interior windshield 304 or otherwise avoid obstructions.

It will be appreciated that the examples robots and methods described herein are potentially applicable to cleaning surfaces other than vehicle interior windshields. For example, any flat or curved surface with hard-to-reach corners or edges can potentially be cleaned using the techniques described herein, including windows and solar panels, such as roof-mounted solar panels and exterior and interior window surfaces of vehicles and buildings. In some cases, the small form factor of the robot provides versatility for cleaning window and solar panel surfaces that are too high or far away to reach, or that are obstructed by other objects.

Other technical features may be readily apparent to one skilled in the art from the figures, descriptions, and claims herein.

### EXAMPLES

Thus, some embodiments may include one or more of the following examples.

Example 1 is a windshield cleaning robot comprising: a chassis comprising a suction pad defining a bottom cavity, the chassis having a low height profile suitable to permit passage of at least a portion of the chassis over each corner of a vehicle interior windshield; a cleaning element configured to remove foreign material from a glass surface; a suction mechanism attached to the chassis to generate negative pressure within the bottom cavity, the negative pressure being sufficient to adhere the windshield cleaning robot to a curved surface of the vehicle interior windshield; and a propulsion system for propelling the windshield cleaning robot across the vehicle interior windshield while the windshield cleaning robot is adhered to the vehicle interior windshield.

In Example 2, the subject matter of Example 1 includes, wherein: the suction mechanism comprises a vacuum motor attached to the chassis and configured to pull air through the cleaning element to generate the negative pressure within the bottom cavity.

In Example 3, the subject matter of Example 2 includes, wherein: the cleaning element extends over a bottom surface of the chassis to cover the bottom cavity.

In Example 4, the subject matter of Examples 1-3 includes, wherein: the propulsion system comprises: two or more wheels, each wheel having a rounded profile to reduce a surface area of the wheel in contact with the vehicle interior windshield; and one or more motors configured to drive the two or more wheels.

In Example 5, the subject matter of Examples 2-4 includes, wherein: the vacuum motor is configured to operate at a speed of more than 75,000 rotations per minute (RPM).

In Example 6, the subject matter of Examples 1-5 includes, wherein: the windshield cleaning robot weighs less than 20 ounces.

In Example 7, the subject matter of Example 6 includes, wherein: the negative pressure generated by the suction mechanism results in a suction force of more than 5,000 Pascals.

In Example 8, the subject matter of Examples 6-7 includes, wherein: the negative pressure generated by the suction mechanism results in a suction force of more than 3,000 Pascals.

In Example 9, the subject matter of Examples 1-8 includes, wherein: the low height profile of the chassis comprises at least one peripheral portion of the chassis having a height of less than 3 inches from the vehicle interior windshield.

In Example 10, the subject matter of Example 9 includes, wherein: the at least one peripheral portion of the chassis has a height of less than 2.5 inches from the vehicle interior windshield.

In Example 11, the subject matter of Examples 1-10 includes, a sprayer for distributing liquid across a surface of the cleaning element.

In Example 12, the subject matter of Example 11 includes, a liquid reclamation system for recovering the liquid from the cleaning element and providing recovered liquid to the sprayer.

In Example 13, the subject matter of Examples 11-12 includes, a control system configured to control the propulsion system to perform operations comprising: performing a complete traversal of the vehicle interior windshield such that the cleaning element passes substantially over an entire exposed area of the vehicle interior windshield; the complete traversal beginning at a first corner of the vehicle interior windshield and ending at a second corner of the vehicle interior windshield diagonally opposite the first corner; the complete traversal being a systematic traversal of the vehicle interior windshield; and the complete traversal being a dry pass to remove particulate matter, performed without liquid on the cleaning element; and performing a second traversal of the vehicle interior windshield such that the cleaning element passes substantially over the entire exposed area of the vehicle interior windshield, the control system controlling the sprayer to distribute the liquid to the cleaning element during the second traversal.

In Example 14, the subject matter of Example 13 includes, wherein: the complete traversal and the second traversal are each performed over a vehicle interior windshield of less than 14 square feet in surface area in less than 5 minutes.

In Example 15, the subject matter of Examples 1-14 includes, wherein: the cleaning element is detachably secured to the bottom surface of the chassis.

In Example 16, the subject matter of Example 15 includes, wherein: the cleaning element is detachably secured to the bottom surface of the chassis by one or more hook and loop fastener surfaces.

Example 17 is a method of cleaning a vehicle interior windshield, the method comprising: providing a windshield cleaning robot having a low height profile suitable to permit passage of at least a portion of the windshield cleaning robot over each corner of the vehicle interior windshield, the windshield cleaning robot comprising: a cleaning element configured to remove foreign material from a glass surface; a suction mechanism configured to generate negative pressure sufficient to adhere the windshield cleaning robot to a curved surface of the vehicle interior windshield at any angle of inclination; and a propulsion system for propelling the windshield cleaning robot across the vehicle interior windshield while the windshield cleaning robot is adhered to the vehicle interior windshield; and controlling the propulsion system to perform a complete traversal of the vehicle interior windshield with the windshield cleaning robot such that the cleaning element passes substantially over an entire exposed area of the vehicle interior windshield.

In Example 18, the subject matter of Example 17 includes, wherein: the complete traversal begins at a first corner of the vehicle interior windshield and ends at a second corner of the vehicle interior windshield diagonally opposite the first corner; and the complete traversal is a systematic traversal of the vehicle interior windshield.

In Example 19, the subject matter of Example 18 includes, wherein: the complete traversal is a dry pass to remove particulate matter, performed without liquid on the cleaning element; and the method further comprises: controlling the propulsion system to perform a second traversal of the vehicle interior windshield with the windshield cleaning robot such that the cleaning element passes substantially over an entire exposed area of the vehicle interior windshield; and controlling a sprayer to distribute liquid to the cleaning element during the second traversal.

In Example 20, the subject matter of Example 19 includes, wherein: the complete traversal and the second traversal are each performed over a vehicle interior windshield of less than 14 square feet in surface area in less than 5 minutes.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

It should be noted that the description and the figures above merely illustrate the principles of the present subject matter along with examples described herein and should not be construed as a limitation to the present subject matter. It is thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all of the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration.

Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few. The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Although the described flow diagrams herein can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially, concurrently, or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A windshield cleaning robot comprising:
a chassis comprising a suction pad defining a bottom cavity, the chassis having a low height profile suitable to permit passage of at least a portion of the chassis over each corner of a vehicle interior windshield;
a cleaning element configured to remove foreign material from a glass surface;
a suction mechanism attached to the chassis to generate negative pressure within the bottom cavity, the negative pressure being sufficient to adhere the windshield cleaning robot to a curved surface of the vehicle interior windshield; and
a propulsion system for propelling the windshield cleaning robot across the vehicle interior windshield while the windshield cleaning robot is adhered to the vehicle interior windshield.

2. The windshield cleaning robot of claim 1, wherein:
the suction mechanism comprises a vacuum motor attached to the chassis and configured to pull air through the cleaning element to generate the negative pressure within the bottom cavity.

3. The windshield cleaning robot of claim 2, wherein:
the cleaning element extends over a bottom surface of the chassis to cover the bottom cavity.

4. The windshield cleaning robot of claim 1, wherein:
the propulsion system comprises:
two or more wheels, each wheel having a rounded profile to reduce a surface area of the wheel in contact with the vehicle interior windshield; and
one or more motors configured to drive the two or more wheels.

5. The windshield cleaning robot of claim 2, wherein:
the vacuum motor is configured to operate at a speed of more than 75,000 rotations per minute (RPM).

6. The windshield cleaning robot of claim 1, wherein:
the windshield cleaning robot weighs less than 20 ounces.

7. The windshield cleaning robot of claim 6, wherein:
the negative pressure generated by the suction mechanism results in a suction force of more than 5,000 Pascals.

8. The windshield cleaning robot of claim 6, wherein:
the negative pressure generated by the suction mechanism results in a suction force of more than 3,000 Pascals.

9. The windshield cleaning robot of claim 1, wherein:
the low height profile of the chassis comprises at least one peripheral portion of the chassis having a height of less than 3 inches from the vehicle interior windshield.

10. The windshield cleaning robot of claim 9, wherein:
the at least one peripheral portion of the chassis has a height of less than 2.5 inches from the vehicle interior windshield.

11. The windshield cleaning robot of claim 1, further comprising:
a sprayer for distributing liquid across a surface of the cleaning element.

12. The windshield cleaning robot of claim 11, further comprising:
a liquid reclamation system for recovering the liquid from the cleaning element and providing recovered liquid to the sprayer.

13. The windshield cleaning robot of claim 11, further comprising:
a control system configured to control the propulsion system to perform operations comprising:
performing a complete traversal of the vehicle interior windshield such that the cleaning element passes substantially over an entire exposed area of the vehicle interior windshield;
the complete traversal beginning at a first corner of the vehicle interior windshield and ending at a second corner of the vehicle interior windshield diagonally opposite the first corner;
the complete traversal being a systematic traversal of the vehicle interior windshield; and
the complete traversal being a dry pass to remove particulate matter, performed without liquid on the cleaning element; and
performing a second traversal of the vehicle interior windshield such that the cleaning element passes substantially over the entire exposed area of the vehicle interior windshield, the control system controlling the sprayer to distribute the liquid to the cleaning element during the second traversal.

14. The windshield cleaning robot of claim 13, wherein:
the complete traversal and the second traversal are each performed over a vehicle interior windshield of less than 14 square feet in surface area in less than 5 minutes.

15. The windshield cleaning robot of claim 1, wherein:
the cleaning element is detachably secured to the bottom surface of the chassis.

16. The windshield cleaning robot of claim 15, wherein:
the cleaning element is detachably secured to the bottom surface of the chassis by one or more hook and loop fastener surfaces.

17. A method of cleaning a vehicle interior windshield, the method comprising:
providing a windshield cleaning robot having a low height profile suitable to permit passage of at least a portion of the windshield cleaning robot over each corner of the vehicle interior windshield, the windshield cleaning robot comprising:
a cleaning element configured to remove foreign material from a glass surface;
a suction mechanism configured to generate negative pressure sufficient to adhere the windshield cleaning robot to a curved surface of the vehicle interior windshield at any angle of inclination; and
a propulsion system for propelling the windshield cleaning robot across the vehicle interior windshield while the windshield cleaning robot is adhered to the vehicle interior windshield; and
controlling the propulsion system to perform a complete traversal of the vehicle interior windshield with the windshield cleaning robot such that the cleaning element passes substantially over an entire exposed area of the vehicle interior windshield.

18. The method of claim 17, wherein:
the complete traversal begins at a first corner of the vehicle interior windshield and ends at a second corner of the vehicle interior windshield diagonally opposite the first corner; and
the complete traversal is a systematic traversal of the vehicle interior windshield.

19. The method of claim 18, wherein:
the complete traversal is a dry pass to remove particulate matter, performed without liquid on the cleaning element; and
the method further comprises:
controlling the propulsion system to perform a second traversal of the vehicle interior windshield with the windshield cleaning robot such that the cleaning element passes substantially over an entire exposed area of the vehicle interior windshield; and
controlling a sprayer to distribute liquid to the cleaning element during the second traversal.

20. The method of claim 19, wherein:
the complete traversal and the second traversal are each performed over a vehicle interior windshield of less than 14 square feet in surface area in less than 5 minutes.
